(19) United States
(12) Patent Application Publication
(10) Pub. No.: US 2014/0204013 A1
(43) Pub. Date: Jul. 24, 2014

(54) PART AND STATE DETECTION FOR GESTURE RECOGNITION

(71) Applicant: MICROSOFT CORPORATION, Redmond, WA (US)

(72) Inventors: Christopher Jozef O'Prey, Bury St Edmunds Suffolk (GB); Jamie Daniel Joseph Shotton, Cambridge (GB); Peter John Ansell, Cambridge (GB)

(73) Assignee: MICROSOFT CORPORATION, Redmond, WA (US)

(21) Appl. No.: 13/744,630

(22) Filed: Jan. 18, 2013

(51) Int. Cl. G06F 3/01; G06K 9/00

(52) U.S. Cl. CPC G06F 3/017; G06K 9/00288
USPC 345/156; 382/159

(57) ABSTRACT

Part and state detection for gesture recognition is useful for human-computer interaction, computer gaming, and other applications where gestures are recognized in real time. In various embodiments a decision forest classifier is used to label image elements of an input image with both part and state labels where part labels identify components of a deformable object, such as finger tips, palm, wrist, lips, laptop lid and where state labels identify configurations of a deformable object such as open, closed, up, down, spread, clenched. In various embodiments the part labels are used to calculate a center of mass of the body parts and the part labels, centers of mass and state labels are used to recognize gestures in real time or near real-time.

### BACKGROUND

Gesture recognition for human-computer interaction, computer gaming and other applications is difficult to achieve with accuracy and in real-time. Many gestures, such as those made using human hands are detailed and difficult to distinguish from one another. Also, equipment used to capture images of gestures may be noisy and error prone.

Some previous approaches have identified body parts in an image of a game player and then, in a separate stage, used the body parts to calculate 3D spatial coordinates of body parts to form a skeletal model of the player. This approach may be computationally intensive and may be prone to errors where the body part identification is not robust. For example, where body part occlusion occurs, where unusual joint angles occur or due to body size and shape variations.

Other previous approaches have used template matching by scaling and rotating images to match stored templates of objects. Large computation power and storage capacity is involved with these types of approach.

The embodiments described below are not limited to implementations which solve any or all of the disadvantages of known gesture recognition systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Part and state detection for gesture recognition is useful for human-computer interaction, computer gaming, and other applications where gestures are recognized in real time. In various embodiments a decision forest classifier is used to label image elements of an input image with both part and state labels where part labels identify components of a deformable object, such as finger tips, palm, wrist, lips, laptop lid and where state labels identify configurations of a deformable object such as open, closed, up, down, spread, clenched. In various embodiments the part labels are used to calculate a center of mass of the body parts and the part labels, centers of mass and state labels are used to recognize gestures in real time or near real-time.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a user operating a desktop computing system using traditional keyboard input, in-air gestures and on-keyboard gestures;

FIG. 2 is a schematic diagram of the capture system and computing device of FIG. 1;

FIG. 3 is a flow diagram of a method of gesture recognition;

FIG. 4 is a schematic diagram of apparatus for generating training data;

FIG. 5 is a schematic diagram of a random decision forest;

FIG. 6 is a schematic diagram of a probability distribution stored at a leaf node of a random decision tree;

FIG. 7 is a schematic diagram of two probability distributions stored at a leaf node of a random decision tree;

FIG. 8 is a schematic diagram of a first second stage random decision forests for classifying part and state;

FIG. 9 is a flow diagram of a method of using a trained random decision forest at test time;

FIG. 10 is a flow diagram of a method of training a random decision forest;

FIG. 11 illustrates an exemplary computing-based device in which embodiments of a gesture recognition system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a part and state recognition system for human hands, the system described is provided as an example and not a limitation. As those skilled in the art will appreciate, the present examples are suitable for application in a variety of different types of part and state recognition systems including but not limited to fully body gesture recognition systems, hand and arm gesture recognition systems, facial gesture recognition systems and systems for recognizing parts and states of articulated objects, deformable objects or static objects. The entity making the gesture to be recognized may be a human, animal, plant or other object (which may or may not be alive) such as a laptop computer.

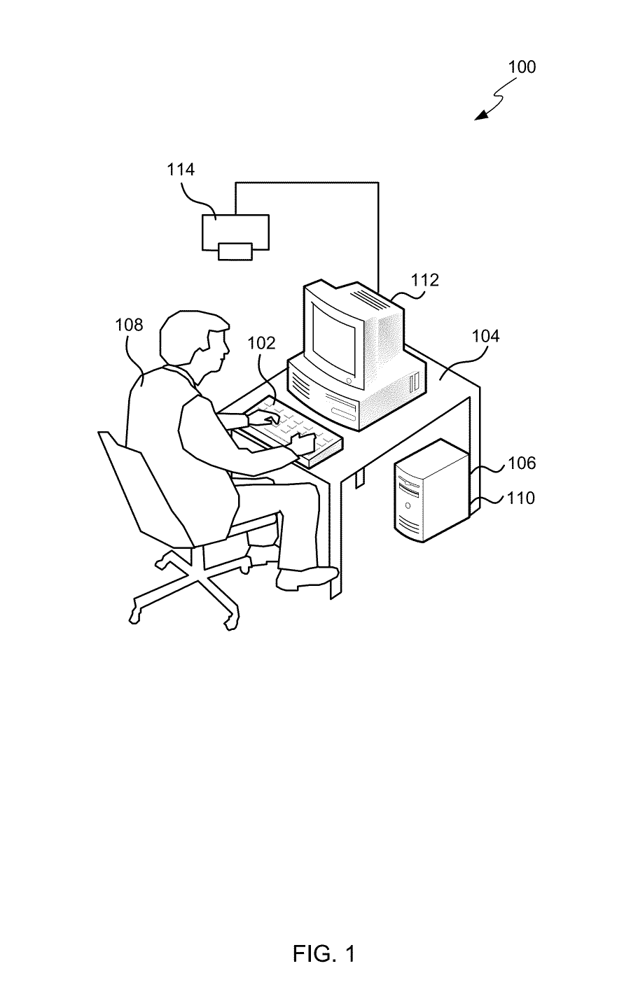

A part and state recognition system is described which comprises a random decision forest trained to classify image elements of images for both part and state. For example, a live video feed of depth images of a person's hand and forearm is processed in real time to detect parts such as finger tips, palm, wrist, forearm and also to detect state such as clenched, spread, up, down. In some examples the part and state labels are simultaneously assigned by the trained forest. This may be used as part of a gesture recognition system for controlling a computing-based device as now described with reference to FIG. 1. However, this is one example; the part and state recognition functionality may be used for other types of gesture recognition or for recognizing parts and states of objects such as laptop computers which may change configuration, or of static objects which may change their orientation with respect to a viewpoint.

Reference is first made to FIG. 1, which illustrates an example control system 100 for controlling a computing-based device 102. In this example, the control system 100 allows the computing-based device 102 to be controlled by traditional input devices (e.g. mouse and keyboard) and hand gestures. The supported hand gestures may be touch hand gestures, free-air gestures or a combination thereof. A “touch hand gesture” is any predefined movement of a hand or hands while in contact with a surface. The surface may or may not include touch sensors. A “free-air gesture” is any predefined movement of a hand or hands in the air where the hand or hands is/are not in contact with a surface.

By integrating both modes of control a user experiences the benefits of each of the control modes in an easy-to use manner. Specifically, many computing-based device 102 activities are tuned to traditional inputs (e.g. mouse and keyboard), in particular those requiring extensive authoring, editing or fine manipulation, such as document writing, coding, creating presentations or graphic design tasks. However, there are elements of these tasks, such as mode switches, windows and task management, menu selection and certain types of navigation which are offloaded to shortcut and modifier keys or context menus which can more easily implemented using other control means, such as touch hand gestures and/or free-air hand gestures.

The computing-based device 102 shown in FIG. 1 is a traditional desktop computer with a separate processor component 104 and display screen 106; however, the methods and systems described herein may equally be applied to computing-based devices 102 wherein the processor component 104 and display screen 106 are integrated such as in a laptop computer or a tablet computer.

The control system 100 further comprises an input device 108, such as a keyboard, in communication with the computing-based device 102 that allows a user to control the computing-based device 102 through traditional means; a capture device 110 for detecting the location and movement of a user's hands with respect to a reference object in the environment (e.g. the input device 108); and software (not shown) to interpret the information obtained from the capture device 110 to control the computing-based device 102. In some examples, at least part of the software for interpreting the information from the capture device 110 is integrated into the capture device 110. In other examples, the software is integrated or loaded on the computing-based device 102. In other examples, the software is located at another entity in communication with the computing-based device 102 such as over the internet.

In FIG. 1, the capture device 110 is mounted above and pointing downward at the user's working surface 112. However, in other examples, the capture device 110 may be mounted in or on the reference object (e.g. keyboard); or another suitable object in the environment.

In operation, the user's hands can be tracked using the capture device 110 with respect to the reference object (e.g. keyboard) such that the position and movements of the user's hands can be interpreted by the computing-based device 102 (and/or the capture device 110) as touch hand gestures and/or free-air hand gestures that can be used to control the application being executed by the computing-based device 102. As a result, in addition to being able to control the computing-based device 102 via traditional inputs (e.g. keyboard and mouse) the user can control the computing-based device 102 by moving his or her hands in a predefined manner or pattern on or above the reference object (e.g. keyboard).

Accordingly, the control system 100 of FIG. 1 is capable of recognizing touch on and around a reference object (e.g. a keyboard) as well as free-air gestures above the reference object.

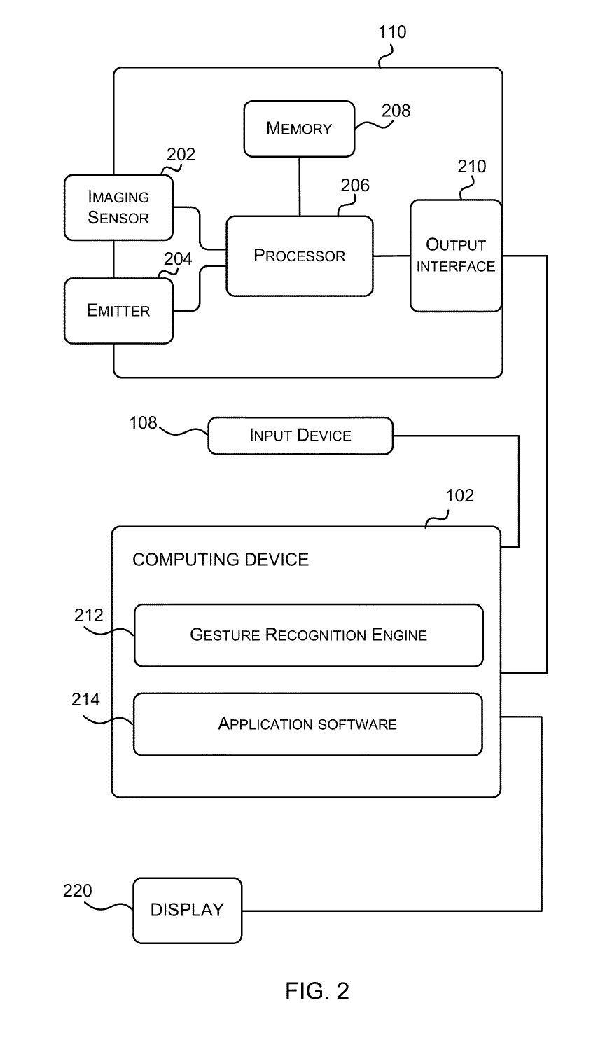

Reference is now made to FIG. 2, which illustrates a schematic diagram of a capture device 110 that may be used in the control system 100 of FIG. 1. The location of the capture device 110 in FIG. 2 is one example only. Other locations for the capture device may be used such as on the desktop looking upwards or other locations. The capture device 110 comprises at least one imaging sensor 202 for capturing a stream of images of the user's hands. The imaging sensor 202 may be any one or more of a depth camera, an RGB camera, an imaging sensor capturing or producing silhouette images where a silhouette image depicts the profile of an object. The imaging sensor 202 may be a depth camera arranged to capture depth information of a scene. The depth information may be in the form of a depth image that includes depth values, i.e. a value associated with each image element of the depth image that is related to the distance between the depth camera and an item or object depicted by that image element.

The depth information can be obtained using any suitable technique including, for example, time-of-flight, structured light, stereo image, or the like.

The captured depth image may include a two dimensional (2-D) area of the captured scene where each image element in the 2-D area represents a depth value such as length or distance of an object in the captured scene from the imaging sensor 202.

In some cases, the imaging sensor 202 may be in the form of two or more physically separated cameras that view the scene from different angles, such that visual stereo data is obtained that can be resolved to generate depth information.

The capture device 110 may also comprise an emitter 204 arranged to illuminate the scene in such a manner that depth information can be ascertained by the imaging sensor 202.

The capture device 110 may also comprise at least one processor 206, which is in communication with the imaging sensor 202 (e.g. depth camera) and the emitter 204 (if present). The processor 206 may be a general purpose microprocessor or a specialized signal/image processor. The processor 206 is arranged to execute instructions to control the imaging sensor 202 and emitter 204 (if present) to capture depth images. The processor 206 may optionally be arranged to perform processing on these images and signals, as outlined in more detail below.

The capture device 110 may also include memory 208 arranged to store the instructions for execution by the processor 206, images or frames captured by the imaging sensor 202, or any suitable information, images or the like. In some examples, the memory 208 can include random access memory (RAM), read only memory (ROM), cache, Flash memory, a hard disk, or any other suitable storage component. The memory 208 can be a separate component in communication with the processor 206 or integrated into the processor 206.

The capture device 110 may also include an output interface 210 in communication with the processor 206. The output interface 210 is arranged to provide data to the computing-based device 102 via a communication link. The communication link can be, for example, a wired connection (e.g. USB™, Firewire™, Ethernet™ or similar) and/or a wireless connection (e.g. WiFi™, Bluetooth™ or similar). In other examples, the output interface 210 can interface with one or more communication networks (e.g. the Internet) and provide data to the computing-based device 102 via these networks.

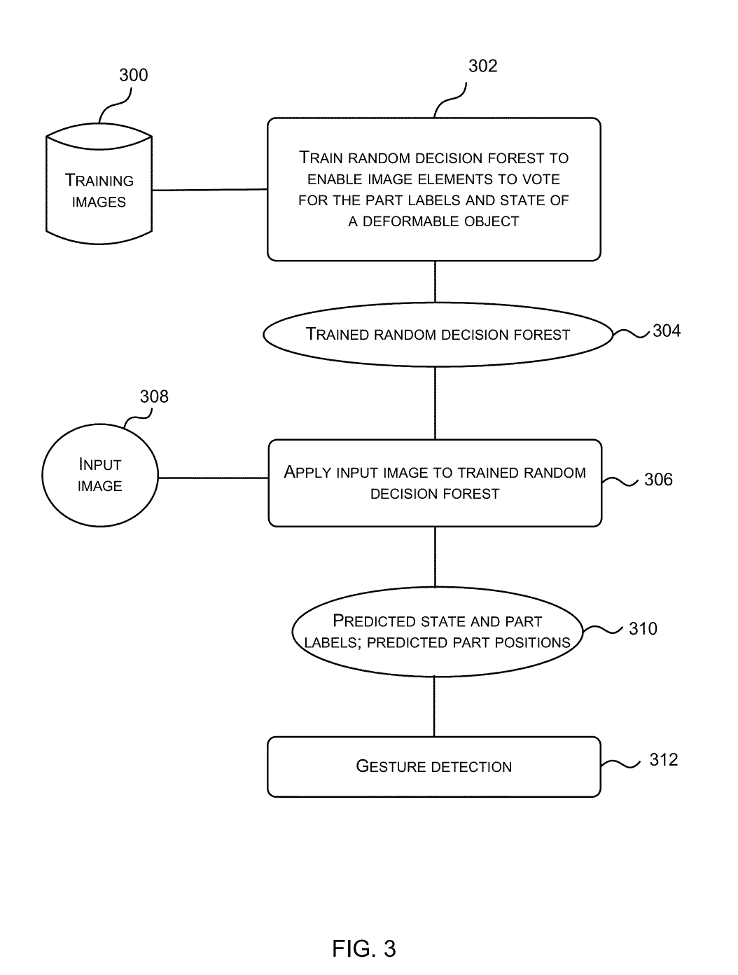

The computing-based device 102 may comprise a gesture recognition engine 212 that is configured to execute one or more functions related to gesture recognition. Example functions that may be executed by the gesture recognition engine are described in reference to FIG. 3. For example, the gesture recognition engine 212 may be configured to classify each image element (e.g. pixel) of the image captured by the capture device 110 as a salient deformable object part (e.g. fingertip, wrist, palm) and as a state (e.g. up, down, open, closed, pointing). The states, parts and optionally center of masses of the parts may be used by a gesture recognition engine 212 as the basis for semantic gesture recognition. This approach to classification leads to a greatly simplified gesture recognition engine 212. For example, it allows some gestures to be recognized by looking for a particular object state for a predetermined number of images, or transitions between object states.

Application software 214 may also be executed on the computing-based device 102 and controlled using the input received from the input device 108 (e.g. keyboard) and the output of the gesture recognition engine 212 (e.g. the detected touch and free-air hand gestures).

FIG. 3 is a flow diagram of a method of gesture recognition. At least part of this method may be carried out at the gesture recognition engine 212 of FIG. 2. At least one trained random decision forest 304 (or other classifier) is accessible to the gesture recognition engine 212. The random decision forest 304 may be created and trained in an offline process 302 and may be stored at the computing-based device 102 or at any other entity in the cloud or elsewhere in communication with the computing-based device 102. The random decision forest 304 is trained to label image elements of an input image 308 with both part and state labels 310 where part labels identify components of a deformable object, such as finger tips, palm, wrist, lips, laptop lid and where state labels identify configurations of an object such as open, closed, spread, clenched or orientations of an object such as up, down. Image elements may be pixels, groups of pixels, voxels, groups of voxels, blobs, patches or other components of an image. The random decision forest 304 provides both part and state labels in a fast, simple manner which is not computationally expensive and which may be performed in real time or near real time on a live video feed from the capture device 110 of FIG. 1 even using conventional computing hardware in a single threaded implementation. Also, the part labels may be used in a fast and accurate process to calculate a center of mass for each part. This enables a 3D location of the object parts to be obtained.

The state and part labels and the centers of mass may be input to a gesture detection system 312 which is greatly simplified as compared with previous gesture detection systems because of the nature of the inputs it works with. For example, the inputs enable some gestures to be recognized by looking for a particular object state for a predetermined number of images, or transitions between object states.

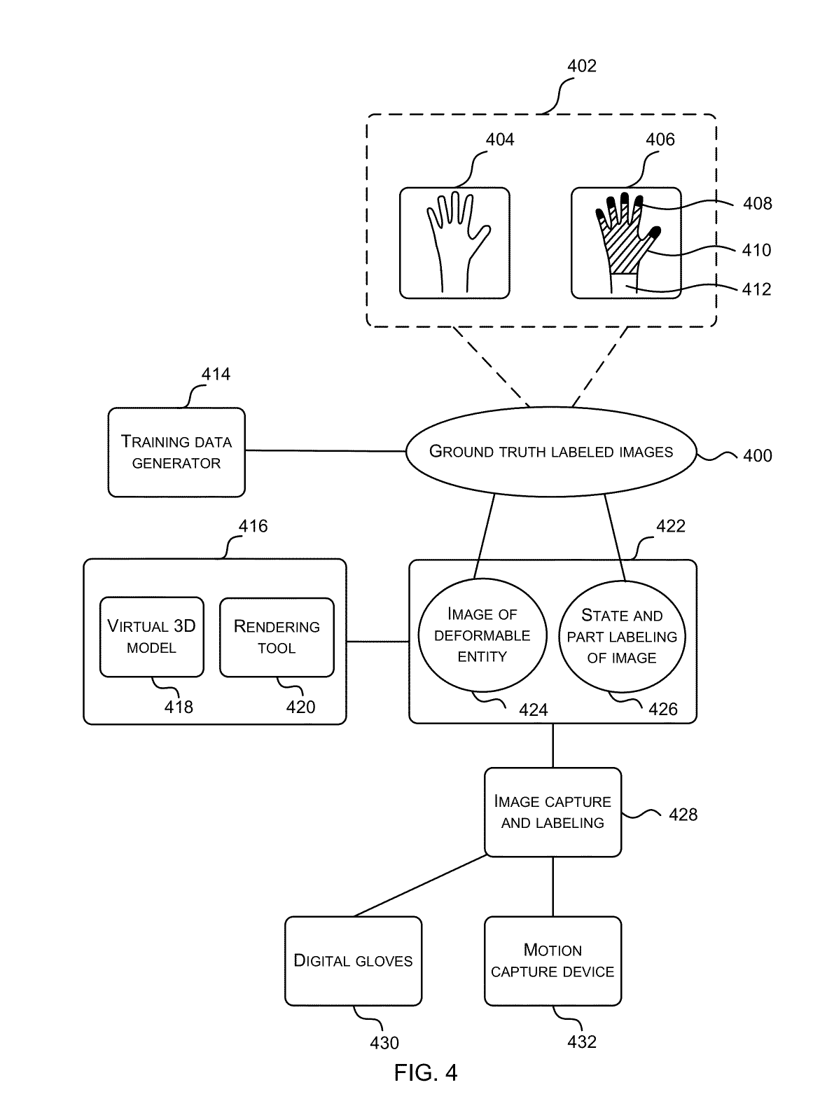

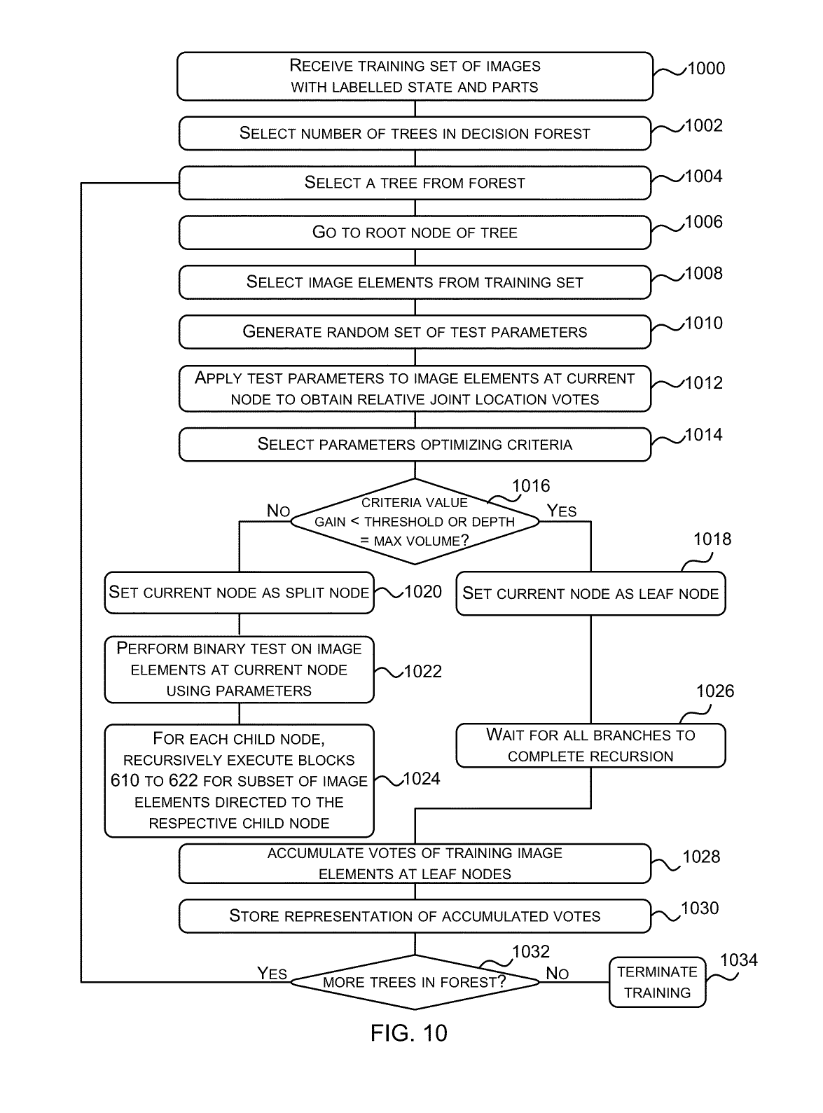

As mentioned above the random decision forest 304 may be trained 302 in an offline process. Training images 300 are used and more detail about how the training images may be obtained is now given with reference to FIG. 4. Detail about a method of training a random decision forest is given later in the document with reference to FIG. 10.

A training data generator 414 which is computer-implemented generates and scores ground truth labeled images 400 also referred to as training images. The ground truth labeled images 400 may comprise many pairs of images, each pair 422 comprising an image of an object 424 and a labeled version of that image 426 where relevant image elements (such as foreground image elements) comprise a part label and at least some of the image elements also comprise a state label. An example of a pair of images 402 is shown schematically in FIG. 4. The pair of images 402 comprises an image of a hand 404 and a labeled version of that image 406 with the fingertips 408 taking one label value, the wrist 412 taking a second label value and the remaining parts of the hand taking a third label value 410. The objects depicted in the training images and the labels used may vary according to the application domain. The variety of examples in the training images of objects and configurations and orientations of those objects is as wide as possible according to the application domain, storage and computing resources available.

The pairs of training images may be synthetically generated using computer graphics techniques. For example, a computer system 416 has access to a virtual 3D model 418 of an object and to a rendering tool 420. Using the virtual 3D model the rendering tool 420 may be arranged to generate a plurality of images of the virtual 3D model in different states and also to produce versions of the rendered images which are labeled for state and part. For example, a virtual 3D model of a human hand is placed in different discrete states that the random decision forest is to classify, and with slight random variations in terms of joint-angle configurations and appearances such as bone lengths and circumference to accommodate different users and styles of gesturing. 2D rendering of the 3D model may be generated automatically from many different plausible viewpoints. One set of renderings may be synthetic depth images in the case where the captured images are depth images. Another set of renderings may be generated with the 3D model textured with labeled data where fingers, forearm and palm are colored and where the color of the palm region is determined based on the current hand state. This results in a plurality of depth images with labeled hand parts and where image elements depicting a palm are also labeled for state. Other regions than the palm may be used for the state, such as the whole hand or the palm and fingers; the example discussed here where the image elements depicting a palm are also labeled for state is one example only.

The pairs of training images may comprise real images from an image capture and labeling component 428 which is computer-implemented. For example, sensors on an object may be used to track its configuration and orientation and label its parts. In the case of hand gestures, digital gloves 430 may be worn by a user who moves his or her hand to make gestures to be detected by the system. The data sensed by the digital gloves 430 may be used to label images captured by a camera.

In some examples a motion capture device 432 is used to record the movements of an object. For example, acoustic, inertial, magnetic, light emitting, reflective or other markers are worn by a person or other deformable object and used to track changes in configuration and orientation of the object.

While the use of synthetic images is useful for precisely annotated images, ensuring that the synthetic images closely match actual images of real hands is difficult. Accordingly, in some examples, in addition to using synthetic images, the use of images of real objects may enhance the accuracy of the system. Another option is to add synthetic noise to the synthetic rendered images.

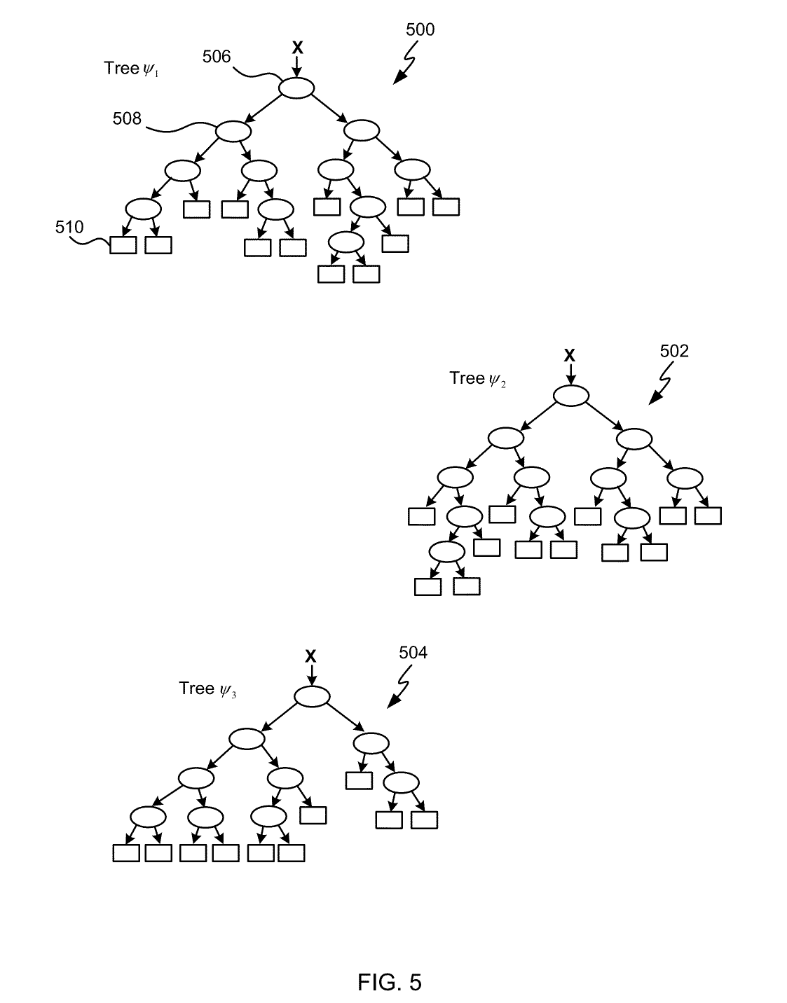

FIG. 5 is a schematic diagram of a random decision forest comprising three random decision trees 500, 502, 504. Two or more random decision trees may be used. Three are shown in this example for clarity. A random decision tree is a type of data structure used to store data accumulated during a training phase so that it may be used to make predictions about examples previously unseen by the random decision tree. A random decision tree is usually used as part of an ensemble of random decision trees (referred to as a forest) trained for a particular application domain in order to achieve generalization (that is, being able to make good predictions about examples which are unlike those used to train the forest). A random decision tree has a root node 506, a plurality of split nodes 508 and a plurality of leaf nodes 510. During training the structure of the tree (the number of nodes and how they are connected) is learnt as well as split functions to be used at each of the split nodes. In addition, data is accumulated at the leaf nodes during training. More detail about the training process is given below with reference to FIG. 10.

In the examples described herein the random decision forest is trained to label (or classify) image elements of an image with both part and state labels. Previously random decision forests have been used to classify image elements of an image with part labels but not with both part and state labels. For a number of reasons it is not straightforward to modify existing random decision forest systems to classify image elements by both part and state. For example, the number of possible combinations of part and state is typically prohibitive for most application domains where there is a real-time processing constraint. Where there are a large number of possible state and part combinations, then using a cross product of state and part as the classes to train a random decision forest is computationally expensive.

In the examples described herein a mixed use of individual pixel level labels (the part labels) and the use of whole image level labels (the state labels) in a single framework enables fast and effective part and state labeling of images for gesture recognition.

Image elements of an image may be pushed through trees of a random decision forest from the root to a leaf node in a process whereby a decision is made at each split node. The decision is made according to characteristics of the image element and characteristics of test image elements displaced therefrom by spatial offsets specified by the parameters at the split node. At a split node the image element proceeds to the next level of the tree down a branch chosen according to the results of the decision. The random decision forest may use regression or classification as described in more detail below. During training, parameter values (also referred to as features) are learnt for use at the split nodes and data comprising part and state label votes are accumulated at the leaf nodes.

Storing all the data accumulated at the leaf nodes during training may be very memory intensive since large amounts of training data are typically used for practical applications. In some embodiments the data is aggregated in order that it may be stored in a compact manner. Various different aggregation processes may be used.

Each leaf node of the decision tree t may store a learned probability distribution Pₜ(c|u) over parts and states c. These distributions may then be aggregated (for example by averaging) across the trees to arrive at a final distribution as shown in the following equation

$$P ( c \vert u ) = \frac{1}{T} {\sum }_{t = 1}^{T} {P}_{t} ( c \vert u )$$

Where P(c|u) is interpreted as a per-image element vote of which hand part the image element belongs to and which hand state it encodes. T is the total number of trees in the forest.

At test time a previously unseen image is input to the trained forest to have its image elements labeled. Each image element of the input image may be sent through each tree of the trained random decision forest and data obtained from the leaves. In this way part and state label votes may be made by comparing each image element with test image elements displaced therefrom by learnt spatial offsets. Each image element may make a plurality of part and state label votes. These votes may be aggregated according to various different aggregation methods to give the predicted part and state labels. The test time process may therefore be a single stage process of applying the input image to the trained random decision forest to directly obtain predicted part and state labels. This single stage process may be carried out in a fast and effective manner to give results in real-time and with high quality results.

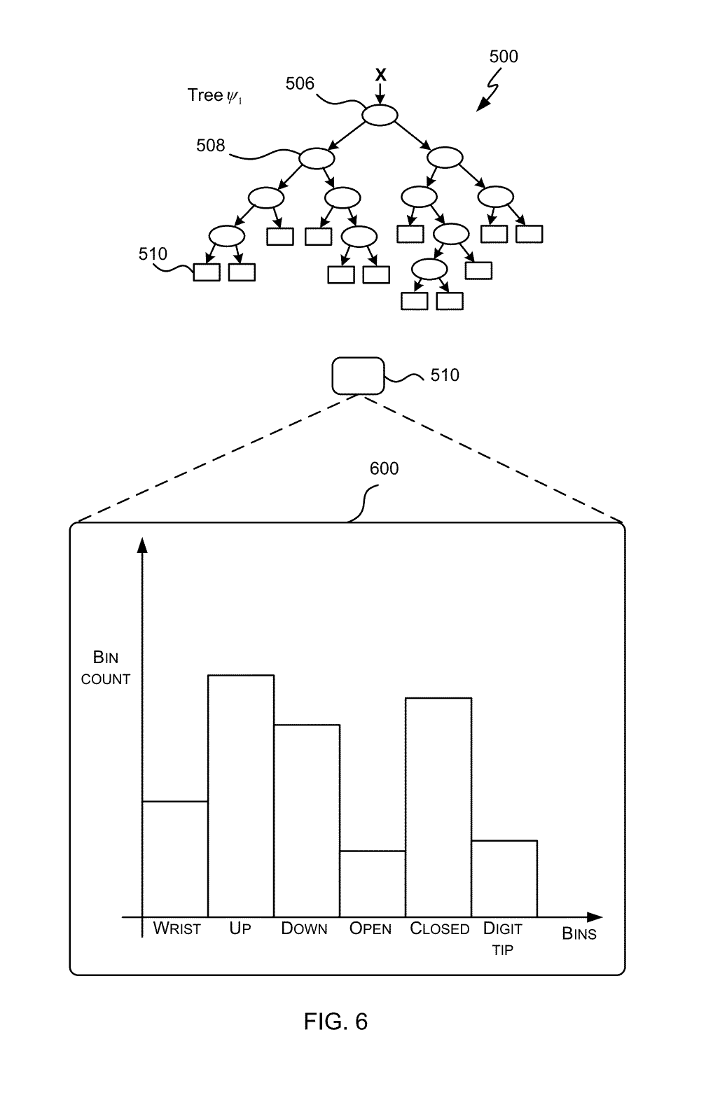

As mentioned above storing the data accumulated at the leaf nodes during training may be very memory intensive since large amounts of training data are typically used for practical applications. This is especially the case where both part and state labels are to be predicted as the number of possible combinations of part and state labels may be high. Thus in some embodiments, state labels are predicted for a subset of the possible parts as now described with reference to FIG. 6.

FIG. 6 is a schematic diagram of one of the random decision forests of FIG. 5 showing data 600 accumulated at leaf node 510 where the data 600 is stored in the form of a histogram. The histogram comprises a plurality of bins and shows a bin count or frequency for each bin. In this example the random decision tree classifies image elements into three possible parts and four possible state labels. The three possible parts are wrist, digit tip and palm. The four possible states are: up, down, open and closed. In this example, state labels are available for palm image elements and not for image elements of other parts. For example, this is because the training data comprised images of hands where fingers, forearm and palm are colored and where the color of the palm varies based on the current hand state. As the state labels are available for at least one but not all of the parts, the number of possible combinations is reduced and the data may be stored in a more compact form that otherwise possible.

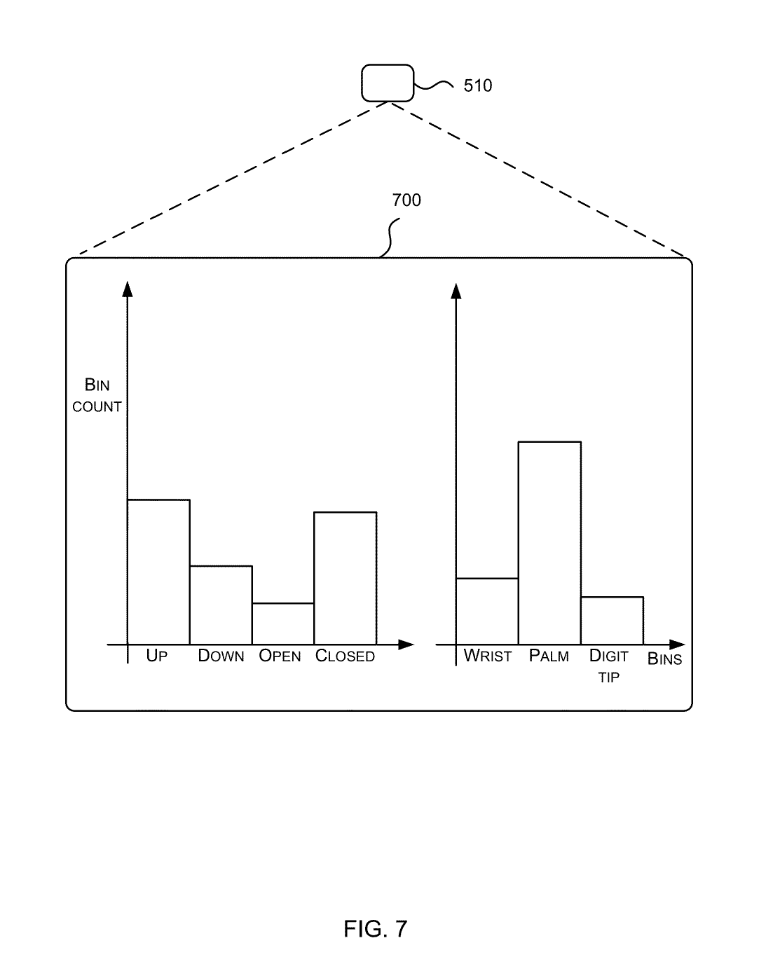

FIG. 7 is a schematic diagram of one of the random decision forests of FIG. 5 showing data 700 accumulated at leaf node 510 where the data 700 is stored in the form of two histograms. One histogram stores state label frequencies and the other histogram stores part label frequencies. This enables more combinations to be represented than in the example of FIG. 6 but without unduly increasing the demand on storage capacity. In this situation the training data may comprise state labels for each of the parts. Another option is to use a single histogram at each leaf to represent all the possible combinations of state and part label. Again, the training data may comprise state labels for each of the parts.

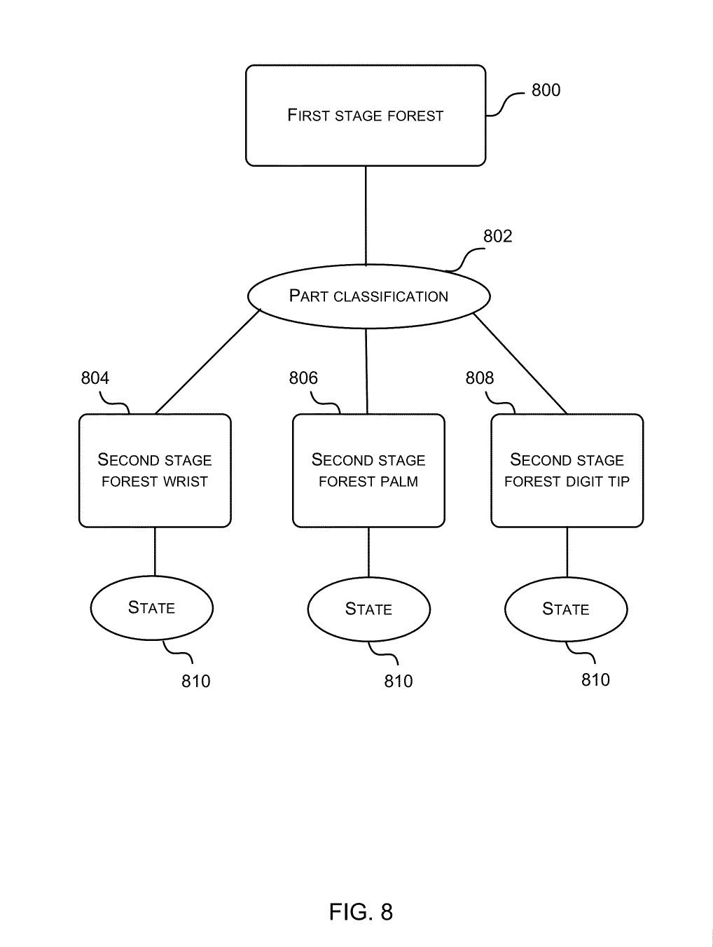

FIG. 8 is a schematic diagram of another embodiment in which a first stage random decision forest 800 is used to classify image elements into parts and give a part classification 802. The part classification 802 is used to select one of a plurality of second stage random decision forests 804, 806, 808. There may be a second stage random decision forest for each possible part classification (such as wrist, palm, digit tip in the example of FIG. 8). Once a second stage random decision forest is selected the test image elements may be input to the selected second stage forest to obtain a state 810 classification for the test image. The first and second stage forests may be trained using the same images although the labels are different to reflect the labeling schemes for the first and second stages.

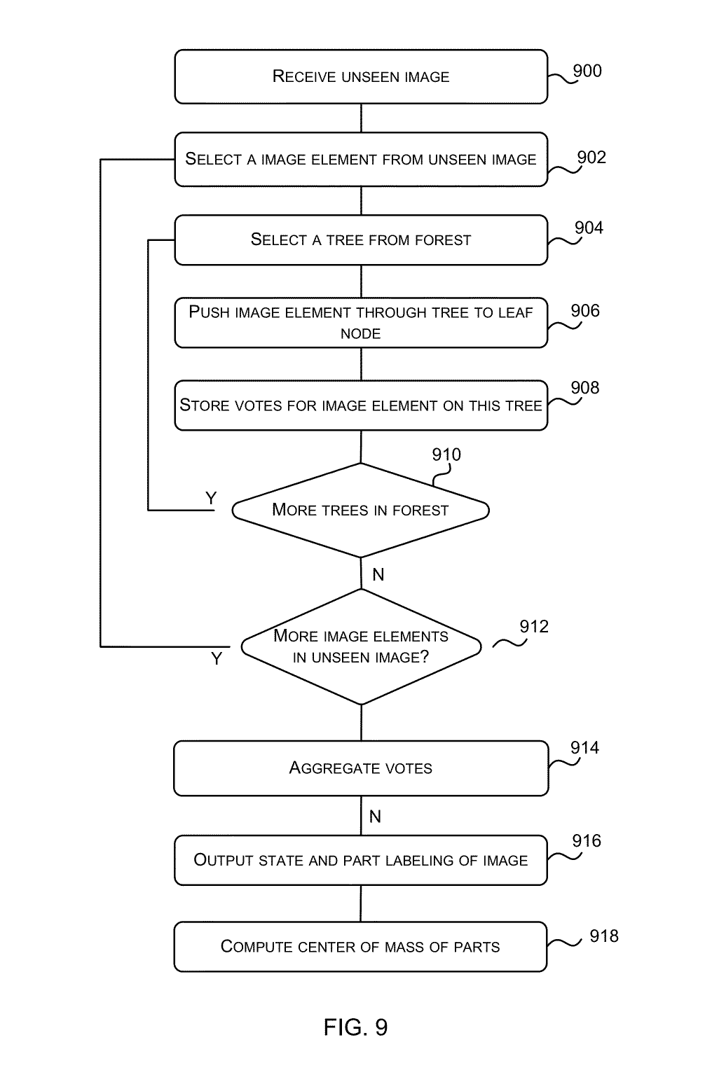

FIG. 9 illustrates a flowchart of a process for predicting part and state labels in a previously unseen image using a decision forest that has been trained using training images labeled for both part and state. The training process is described with reference to FIG. 10 below. Firstly, an unseen image is received 900. An image is referred to as ‘unseen’ to distinguish it from a training image which has the part and state labels already specified. Note that the unseen image can be pre-processed to an extent, for example to identify foreground regions, which reduces the number of image elements to be processed by the decision forest. However, pre-processing to identify foreground regions is not essential. In some examples the unseen image is a silhouette image, a depth image or a color image.

An image element from the unseen image is selected 902. A trained decision tree from the decision forest is also selected 904. The selected image element is pushed 906 through the selected decision tree, such that it is tested against the trained parameters at a node, and then passed to the appropriate child in dependence on the outcome of the test, and the process repeated until the image element reaches a leaf node. Once the image element reaches a leaf node, the accumulated part and state label votes (from the training stage) associated with this leaf node are stored 908 for this image element. The part and state label votes may be in the form of a histogram as described with reference to FIGS. 6 and 7 or may be in another form.

If it is determined 910 that there are more decision trees in the forest, then a new decision tree is selected 904, the image element pushed 906 through the tree and the accumulated votes stored 908. This is repeated until it has been performed for all the decision trees in the forest. Note that the process for pushing an image element through the plurality of trees in the decision forest can also be performed in parallel, instead of in sequence as shown in FIG. 9.

It is then determined 912 whether further unanalyzed image elements are present in the unseen image, and if so another image element is selected and the process repeated. Once all the image elements in the unseen image have been analyzed, then part and state label votes are obtained for all image elements.

As the image elements are pushed through the trees in the decision forest, votes accumulate. For a given image element the accumulated votes are aggregated 914 across trees in the forest to form an overall vote aggregation for each image element. Optionally a sample of votes may be taken for aggregation. For example, N votes may be chosen at random, or by taking the top N weighted votes, and then the aggregation process applied only to those N votes. This enables accuracy to be traded off against speed.

At least one set of part and state labels may then be output 916 where the labels may be confidence weighted. This helps any subsequent gesture recognition algorithm (or other process) assess whether the proposal is good or not. More than one set of part and state labels may be output; for example, where there is uncertainty.

A center of mass for each part may be computed 918. For example, this may be achieved by using a mean shift process to compute a center of mass for each part. Other processes may be used to compute the center of mass. The per-image element state classifications may also be aggregated across all relevant image elements. For example, the relevant image elements may be those depicting the palm in the example described above. The aggregation of the per-image element state classifications may be carried out in various ways including each image element in the palm (or other relevant region) casting a discrete vote for the global state, or each image element casting soft (probabilistic) votes based on the probabilities, or only some image elements casting votes if they are sufficiently confident about their votes.

FIG. 10 is a flowchart of a process for training a decision forest to assign part and state labels to image elements of an image. This can also be thought of as generating part and state label votes for image elements of an image. The decision forest is trained using a set of training images as described above with reference to FIG. 4.

Referring to FIG. 10, to train the decision trees, the training set described above is first received 1000. The number of decision trees to be used in a random decision forest is selected 1002. A random decision forest is a collection of deterministic decision trees. Decision trees can be used in classification or regression algorithms, but can suffer from over-fitting, i.e. poor generalization. However, an ensemble of many randomly trained decision trees (a random forest) yields improved generalization. During the training process, the number of trees is fixed.

The following notation is used to describe the training process. An image element in an image I is defined by its coordinates x=(x, y). The forest is composed of T trees denoted Ψ₁, . . . , Ψₜ, . . . , Ψ_{T} with t indexing each tree.

In operation, each root and split node of each tree performs a binary test on the input data and based on the result directs the data to the left or right child node. The leaf nodes do not perform any action; they store accumulated part and state label votes (and optionally other information). For example, probability distributions may be stored representing the accumulated votes.

The manner in which the parameters used by each of the split nodes are chosen and how the leaf node probabilities may be computed is now described. A decision tree from the decision forest is selected 1004 (e.g. the first decision tree) and the root node 1006 is selected 1006. At least a subset of the image elements from each of the training images are then selected 1008. For example, the image may be segmented so that image elements in foreground regions are selected.

A random set of test parameters are then generated 1010 for use by the binary test performed at the root node as candidate features. In one example, the binary test is of the form: ξ>ƒ (x;θ)>τ, such that ƒ (x; θ) is a function applied to image element x with parameters θ, and with the output of the function compared to threshold values ξ and τ. If the result of ƒ (x; θ) is in the range between ξ and τ then the result of the binary test is true. Otherwise, the result of the binary test is false. In other examples, only one of the threshold values ξ and τ can be used, such that the result of the binary test is true if the result of ƒ (x; θ) is greater than (or alternatively less than) a threshold value. In the example described here, the parameter θ defines a feature of the image.

A candidate function ƒ (x; θ) can only make use of image information which is available at test time. The parameter θ for the function ƒ (x; θ) is randomly generated during training. The process for generating the parameter θ can comprise generating random spatial offset values in the form of a two or three dimensional displacement. The result of the function ƒ (x; θ) is then computed by observing an image element value (such as depth in the case of a depth image, intensity or another quantity depending on the type of images being used) for a test image element which is displaced from the image element of interest x in the image by the spatial offset. The spatial offsets are optionally made invariant to the quantity being assessed by scaling by 1/the quantity of the image element of interest. The threshold values ξ and τ can be used to decide whether the test image element has a particular combination of part and state label.

The result of the binary test performed at a root node or split node determines which child node an image element is passed to. For example, if the result of the binary test is true, the image element is passed to a first child node, whereas if the result is false, the image element is passed to a second child node.

The random set of test parameters generated comprise a plurality of random values for the function parameter θ and the threshold values ξ and τ. In order to inject randomness into the decision trees, the function parameters θ of each split node are optimized only over a randomly sampled subset Θ of all possible parameters. This is an effective and simple way of injecting randomness into the trees, and increases generalization.

Then, every combination of test parameter may be applied 1012 to each image element in the set of training images. In other words, available values for θ (i.e. θₗεΘ) are tried one after the other, in combination with available values of ξ and τ for each image element in each training image. For each combination, criteria (also referred to as objectives) are calculated 1014. In an example, the calculated criteria comprise the information gain (also known as the relative entropy) of the histogram or histograms over parts and states. The combination of parameters that optimize the criteria (such as maximizing the information gain (denoted θ*, ξ* and τ*)) is selected 1014 and stored at the current node for future use. As an alternative to information gain, other criteria can be used, such as Gini entropy, or the ‘two-ing’ criterion or others.

It is then determined 1016 whether the value for the calculated criteria is less than (or greater than) a threshold. If the value for the calculated criteria is less than the threshold, then this indicates that further expansion of the tree does not provide significant benefit. This gives rise to asymmetrical trees which naturally stop growing when no further nodes are beneficial. In such cases, the current node is set 1018 as a leaf node. Similarly, the current depth of the tree is determined (i.e. how many levels of nodes are between the root node and the current node). If this is greater than a predefined maximum value, then the current node is set 1018 as a leaf node. Each leaf node has part and state label votes which accumulate at that leaf node during the training process as described below.

It is also possible to use another stopping criterion in combination with those already mentioned. For example, to assess the number of example image elements that reach the leaf. If there are too few examples (compared with a threshold for example) then the process may be arranged to stop to avoid overfitting. However, it is not essential to use this stopping criterion.

If the value for the calculated criteria is greater than or equal to the threshold, and the tree depth is less than the maximum value, then the current node is set 1020 as a split node. As the current node is a split node, it has child nodes, and the process then moves to training these child nodes. Each child node is trained using a subset of the training image elements at the current node. The subset of image elements sent to a child node is determined using the parameters that optimized the criteria. These parameters are used in the binary test, and the binary test performed 1022 on all image elements at the current node. The image elements that pass the binary test form a first subset sent to a first child node, and the image elements that fail the binary test form a second subset sent to a second child node.

For each of the child nodes, the process as outlined in blocks 1010 to 1022 of FIG. 10 are recursively executed 1024 for the subset of image elements directed to the respective child node. In other words, for each child node, new random test parameters are generated 1010, applied 1012 to the respective subset of image elements, parameters optimizing the criteria selected 1014, and the type of node (split or leaf) determined 1016. If it is a leaf node, then the current branch of recursion ceases. If it is a split node, binary tests are performed 1022 to determine further subsets of image elements and another branch of recursion starts. Therefore, this process recursively moves through the tree, training each node until leaf nodes are reached at each branch. As leaf nodes are reached, the process waits 1026 until the nodes in all branches have been trained. Note that, in other examples, the same functionality can be attained using alternative techniques to recursion.

Once all the nodes in the tree have been trained to determine the parameters for the binary test optimizing the criteria at each split node, and leaf nodes have been selected to terminate each branch, then votes may be accumulated 1028 at the leaf nodes of the tree. The votes comprise additional counts for the parts and the states in the histogram or histograms over parts and states. This is the training stage and so particular image elements which reach a given leaf node have specified part and state label votes known from the ground truth training data. A representation of the accumulated votes may be stored 1030 using various different methods. The histograms may be of a small fixed dimension so that storing the histograms is possible with a low memory footprint.

Once the accumulated votes have been stored it is determined 1032 whether more trees are present in the decision forest. If so, then the next tree in the decision forest is selected, and the process repeats. If all the trees in the forest have been trained, and no others remain, then the training process is complete and the process terminates 1034.

Therefore, as a result of the training process, one or more decision trees are trained using synthesized or empirical training images. Each tree comprises a plurality of split nodes storing optimized test parameters, and leaf nodes storing associated part and state label votes or representations of aggregated part and state label votes. Due to the random generation of parameters from a limited subset used at each node, the trees of the forest are distinct (i.e. different) from each other.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

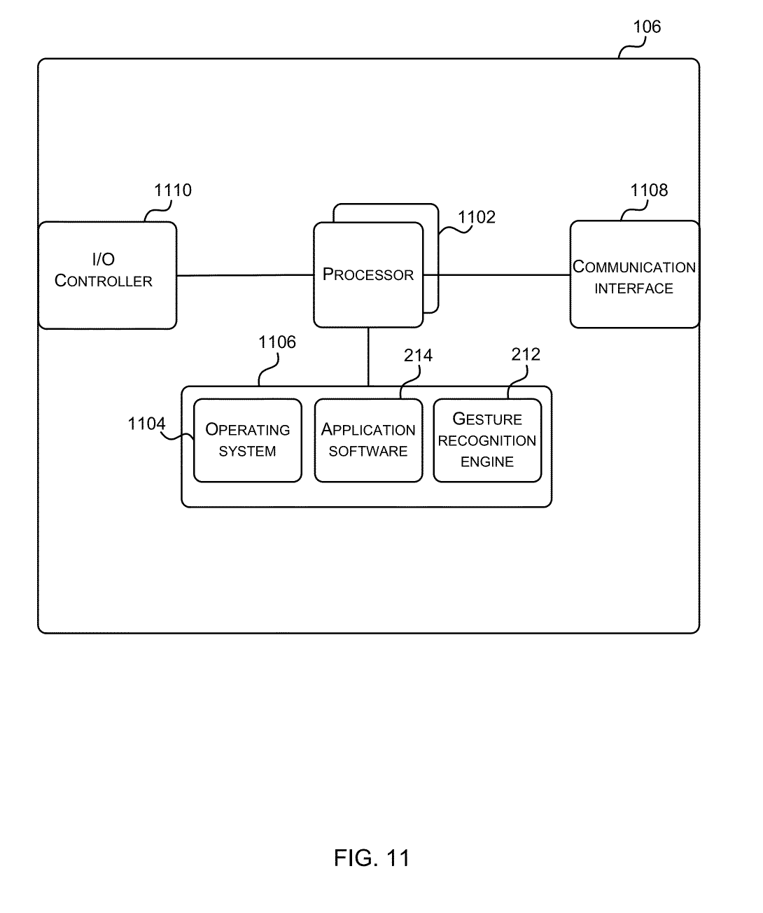

FIG. 11 illustrates various components of an exemplary computing-based device 102 which may be implemented as any form of a computing and/or electronic device, and in which embodiments of the systems and methods described herein may be implemented.

Computing-based device 102 comprises one or more processors 1102 which may be microprocessors, controllers or any other suitable type of processors for processing computer executable instructions to control the operation of the device in order to label image elements for both state and part to enable simplified gesture recognition. In some examples, for example where a system on a chip architecture is used, the processors 1102 may include one or more fixed function blocks (also referred to as accelerators) which implement a part of the method of controlling the computing-based device in hardware (rather than software or firmware). Platform software comprising an operating system 1104 or any other suitable platform software may be provided at the computing-based device to enable application software 214 to be executed on the device.

The computer executable instructions may be provided using any computer-readable media that is accessible by computing based device 102. Computer-readable media may include, for example, computer storage media such as memory 1106 and communications media. Computer storage media, such as memory 1106, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing-based device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1106) is shown within the computing-based device 102 it will be appreciated that the storage may be distributed or located remotely and accessed via a network or other communication link (e.g. using communication interface 1108).

The computing-based device 102 also comprises an input/output controller 1110 arranged to output display information to a display device 106 (FIG. 1) which may be separate from or integral to the computing-based device 102. The display information may provide a graphical user interface. The input/output controller 1110 is also arranged to receive and process input from one or more devices, such as a user input device 108 (FIG. 1) (e.g. a mouse, keyboard, camera, microphone or other sensor). In some examples the user input device 108 may detect voice input, user gestures or other user actions and may provide a natural user interface (NUI). In an embodiment the display device 106 may also act as the user input device 108 if it is a touch sensitive display device. The input/output controller 1110 may also output data to devices other than the display device, e.g. a locally connected printing device (not shown in FIG. 11).

The input/output controller 1110, display device 106 and optionally the user input device 108 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method comprising:
receiving, at a processor, an image depicting at least one object;
applying the received image to a trained random decision forest to recognize both a plurality of parts of the object depicted in the image and a state of the object, where a state is an orientation or a configuration.

2. A method as claimed in claim 1 comprising receiving a stream of images depicting the object and applying the stream of images to the trained random decision forest to track recognition of both the parts and the state in real time.

3. A method as claimed in claim 1 wherein the received image comprises any of a depth image, a color image and a silhouette image.

4. A method as claimed in claim 1 wherein the at least one object comprises a human hand and wherein the plurality of parts comprise: palm, wrist, digit tip.

5. A method as claimed in claim 1 wherein the at least one object comprises a human hand and wherein the state is any of: open, closed, up, down, clenched, spread.

6. A method as claimed in claim 1 wherein the trained random decision forest recognizes the plurality of parts and the state simultaneously.

7. A method as claimed in claim 1 wherein the trained random decision forest assigns part and state labels to image elements of the received image.

8. A method as claimed in claim 1 comprising calculating a center of mass of each of the recognized parts.

9. A method as claimed in claim 1 wherein applying the received image to the trained random decision forest results in state labels for a plurality of image elements of the received image and the method comprises aggregating the state labels.

10. A method as claimed in claim 2 comprising using the tracked recognized parts and state to recognize at least one gesture.

11. A method as claimed in claim 1 the random decision forest having been trained to store joint probability distributions over part and state labels at leaf nodes of the random decision forest.

12. A method as claimed in claim 1 comprising applying the received image to a first stage random decision forest to obtain a part classification and applying image elements of the received image to selected ones of a plurality of second stage random decision forests to obtain state classifications.

13. A method comprising:
accessing, at a processor, a plurality of training images of an object, each training image comprising part and state labels which classify image elements of the training image into a plurality of possible parts of the object and into one of a plurality of states which are orientations or configurations of the object;
training a random decision forest, using the accessed training images, to classify image elements of an image into both parts and state.

14. A method as claimed in claim 13 wherein the training images have state labels for only one of the object parts.

15. A method as claimed in claim 13 where training the random decision forest comprises storing joint probability distributions over part and state labels at leaf nodes of the random decision forest.

16. A method as claimed in claim 13 where training the random decision forest comprises storing a histogram of part and state labels at leaf nodes of the random decision forest, the histogram having bins for a plurality of states for some but not all of the parts.

17. A method as claimed in claim 13 where training the random decision forest comprises storing at leaf nodes of the random decision forest, a first histogram of part labels and a second histogram of states.

18. An apparatus comprising:
an interface arranged to receive an image depicting at least one object;
a gesture recognition engine arranged to applying the received image to a trained random decision forest to recognize both a plurality of parts of the object depicted in the image and a state of the object, where a state is an orientation or a configuration.

19. An apparatus as claimed in claim 18 the gesture recognition engine being at least partially implemented using hardware logic selected from any one or more of: a field-programmable gate array, a program-specific integrated circuit, a program-specific standard product, a system-on-a-chip, a complex programmable logic device, a graphics processing unit.

20. An apparatus as claimed in claim 18 the interface arranged to receive a stream of images depicting the object and the gesture recognition engine arranged to operate on the stream of images in real time.
